(19) United States
(12) Patent Application Publication
(10) Pub. No.: US 2007/0206825 A1
(43) Pub. Date: Sep. 6, 2007

(54) Noise reduction circuit for hearing aid

(75) Inventor: Samuel L. Thomasson, Gilbert, AZ (US)

Correspondence Address: Paul F. Wille, 6407 East Clinton St., Scottsdale, AZ, 85254, US

(73) Assignee: Zounds, Inc., Mesa, AZ (US)

(21) Appl. No.: 11/336,125

(22) Filed: Jan. 20, 2006

(51) Int. Cl. H04R 25/00

(52) U.S. Cl. 381/317; 381/312

(57) ABSTRACT

Noise reduction circuitry in a hearing aid includes a programmable filter coupled to a microphone coupled to the ear canal. The filter is programmed in a feedback loop in which the coefficients of the filter are set in accordance with a signal from the microphone. The filter is programmed for a transfer function that is substantially the inverse of the spectrum of the sound detected by the microphone to provide a relatively quiet chamber in the ear canal.

### BACKGROUND OF THE INVENTION

This invention relates to hearing aids and, in particular, to a hearing aid that provides a quiet chamber for a hearing test.

It is estimated that more than twenty million people in the United States have some degree of hearing loss. Unfortunately, few people include hearing tests as a part of their regular health care due, in part, to the inconvenience and expense of a test.

A hearing test is typically conducted in a clinical setting by a licensed professional, such as an audiologist, who administers the hearing test manually. The administrator controls an audiometer to produce a series of tones that have a specific frequency (Hz) and amplitude (dB). The subject wears a headphone and listens for the tones in each ear in a quiet room or in a sonic isolation booth. The subject gestures if he has heard a tone. If a tone is not heard, the administrator adjusts the amplitude of the tone until it is audible to the subject. By repeating this process for several different frequencies for each ear and compiling the results, the administrator determines the auditory acuity of the subject.

Hearing tests are relatively expensive, as are hearing aids, compared with eye exams and corrective lenses, for example. Expense and other factors make people reluctant to keep their hearing tests current. It is known in the art to provide self-administered hearing tests; e.g. see Published U.S. Application 2004/0006283 (Harrison et al.). A problem with such systems is the ability of the subject to self-administer. Settling a subject down in a self-test system makes monitoring of the test more difficult. Another problem is the need for quiet. Unless one has experienced an anechoic chamber, one does not realize how much ambient noise there is, even in supposedly quiet areas. (Even an anechoic chamber is not silent because ones heartbeat and respiration become quite noticeable.) Noise, particularly random (“white” or “pink”) noise, can hide a tone of low amplitude, possibly making a subject's auditory acuity seem less than it is.

Thus, there is a need for a hearing test that overcomes the shortcomings of traditional and self-administered hearing tests. Specifically, there is a need for apparatus that is even simpler, more convenient, and less expensive than existing systems, yet provides results comparable to a traditional hearing test by a licensed professional using a sonic isolation booth.

It is known in the art to provide headphones with noise cancellation circuitry. U.S. Pat. No. 6,683,965 (Sapiejewski) discloses an in-the-outer-ear (auricle) headphone having a microphone within the earpiece to pick up noise from the auricle. A similar structure is disclosed in U.S. Pat. No. 5,305,387 (Sapiejewski) and U.S. Pat. No. 5,497,426 (Jay), except that the headphone fits over the ear. In all three disclosures, the signal from the microphone is subtracted from the signal applied to the headphone. Subtraction necessarily produces a frequency dependent error because of time delays in the electronics and primarily in the propagation of sound waves. A given delay could represent a phase shift of only 5° or so, which is insignificant, at low frequencies or a phase shift of 130° or more at higher frequencies, which is significant.

It is known in the art to couple to an ear canal either pneumatically or electrically; see U.S. Pat. No. 5,987,146 (Pluvinage et al.). In the Pluvinage et al. patent, the microphone is the input to the hearing aid. The auricle is used for directionality.

In view of the foregoing, it is therefore an object of the invention to provide a hearing aid that reduces noise in the ear canal and is suitable for use during a hearing test.

Another object of the invention is to provide a hearing aid that can use the noise reduction circuitry during routine tasks.

A further object of the invention is to provide noise reduction rather than noise subtraction.

Another object of the invention is to provide a noise reduction system that is compatible with existing hearing tests, including self-tests, without the need for a special chamber.

A further object of the invention is to provide a noise reduction circuit that reduces the cost of a hearing test.

### SUMMARY OF THE INVENTION

The foregoing objects are achieved by the invention in which a hearing aid is modified to reduce noise within a subject's ear canal and is then used during a hearing test to maintain quiet. The inner portion of the ear canal is made a quiet chamber suitable for a hearing test.

### BRIEF DESCRIPTION OF THE DRAWINGS

A more complete understanding of the invention can be obtained by considering the following detailed description in conjunction with the accompanying drawings, in which:

FIG. 1 is a sectional view of a hearing aid constructed in accordance with a preferred embodiment of the invention installed in a human ear canal;

FIG. 2 is block diagram of signal processing circuitry within the hearing aid illustrated in FIG. 1;

FIG. 3 is a diagram for explaining the operation of the filter in FIG. 2;

FIG. 4 is a perspective view of a behind the ear hearing aid constructed in accordance with the invention; and

FIG. 6 is block diagram of an alternative embodiment of signal processing circuitry within the hearing aid illustrated in FIG. 1.

### DETAILED DESCRIPTION OF THE INVENTION

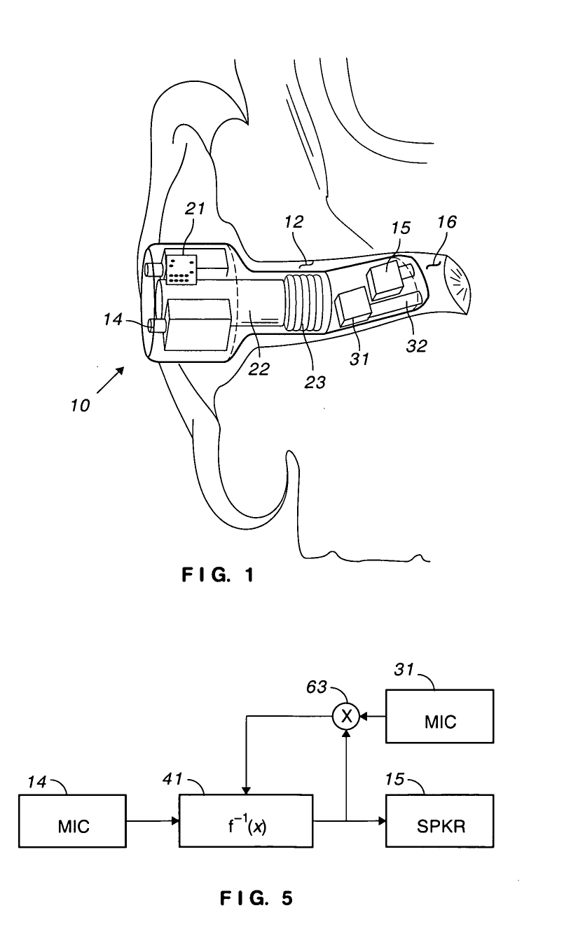

In FIG. 1, hearing aid 10 is located substantially within ear canal 12 and may, but need not, seal or plug the canal. In other words, the invention works with vented or unvented hearing aids, vented is preferred. Hearing aid 10 includes at least one external microphone, such as microphone 14. By “external” is meant that the microphone faces away from the subject for picking up sounds incident upon the user's ear from outside the body. Hearing aid 10 also includes internal speaker 15 for producing sounds within ear canal 12; specifically, within chamber 16 formed at the inner end of ear canal 12.

Hearing aid 10 also includes a flex circuit or integrated circuit 21 containing a microprocessor for signal processing and other tasks, rechargeable battery 22 for power, and inductor 23, all of which are electrically coupled to circuit 21, as are the other electrical components. Dedicated electronics can be used instead of programmable electronics but programmable electronics are preferred.

In accordance with the invention, hearing aid 10 also includes internal microphone 31 acoustically coupled to chamber 16 by port 32 for picking up sounds within the chamber. Microphone 31 is used in a feedback loop for reducing noise in chamber 16.

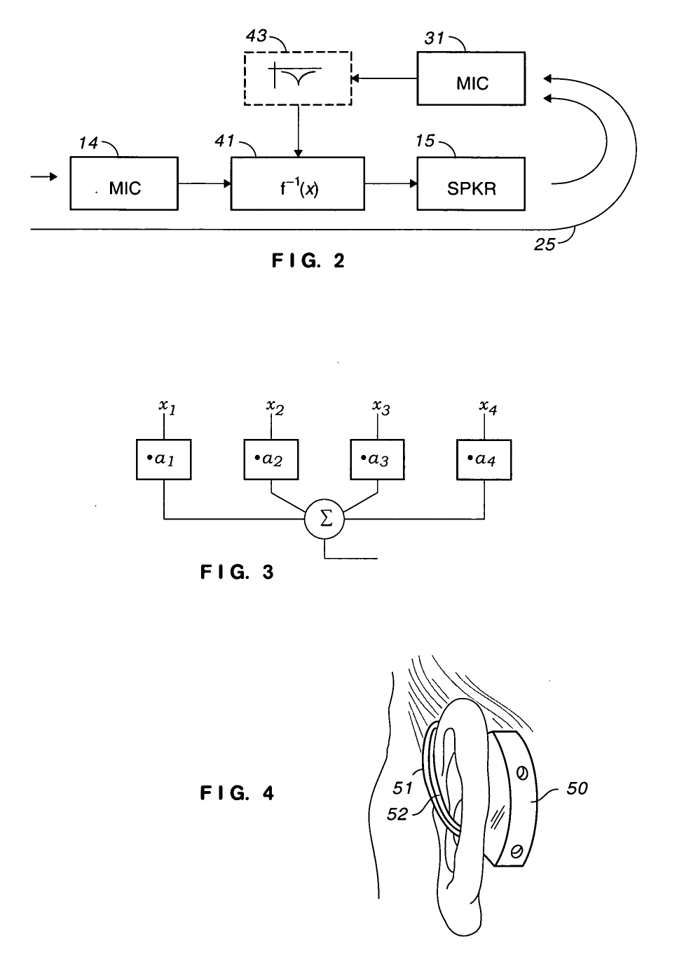

As illustrated in FIG. 2, microphone 14 is coupled to programmable filter 41, which is a digital signal processor (DSP) having two to eight taps. The taps define coefficients for the filter, which, in turn, define the filter characteristics or transfer function of the filter. The maximum number of taps is determined primarily by power consumption and cost. Using present technology, a circuit having more than eight taps dissipates too much power.

FIG. 3 illustrates the operation of filter 41. An incoming signal from microphone 31 is sampled, e.g. at the rate of sixteen kilohertz. Two to eight samples form a “window” wherein each sample xₙ is weighted by multiplying by aₙ and then combined with the other weighted samples to produce an output signal representing the sum of the samples. When the coefficients provide a transfer function that is the inverse of the sound in the ear, the output is a minimum. The weighting factor a decreases with increasing amplitude of the signal from microphone 31. The number of windows needed to train the coefficients to produce minimal sound in the chamber 16 (FIG. 1) depends upon the nature of the sound. Successive windows producing a change in coefficients less than some threshold, ξ, indicates convergence or a minimum for the particular circumstances of the test.

In operation, a subject is provided with a relatively quiet room, typically having the sound of air rushing through ventilation ducts and the hum of electrical equipment, plus whatever sounds penetrate the room from outside. The circuit is activated for each ear separately (two hearing aids) and the filter is programmed by the microprocessor in circuit 21. Some of the external sound incident upon microphone 14 leaks past hearing aid 10 (FIG. 1), as indicated by line 25 in FIG. 2. The sound incident upon microphone 31 is a mixture of filtered sound, about ninety percent, and external sound, about ten percent. Sound leakage is another reason why chamber 16 (FIG. 1) cannot be made completely silent. Once programmed, filter 41 preferably remains unchanged for a subsequent hearing test. The signal from microphone 14 is filtered by filter 41 for noise reduction during the test.

The invention provides several advantages over the prior art. A first is that background noise is reduced, which has the effect of decreasing the threshold of hearing. A person's hearing seems to become more sensitive because background noise no longer drowns out a test signal of low amplitude. Thus, one obtains a more accurate picture of the person's hearing response. Another advantage is mobility. An audiologist is not tied to a specialized office and avoids the expense of a sonic isolation booth or room.

For a hearing test, the subject wears a headphone coupled to a suitable audiometer and the test is conducted in the usual manner. Because tones are being applied, one can let the control loop run during the test and filter out the tone from the loop with optional notch filter 43, as indicated in FIG. 2.

In FIG. 4, behind the ear hearing aid 50 includes conductor 51 and 52. The conductors begin in hearing aid 50 and terminate in the ear canal of a user. Conductor 51 is coupled to a microphone (not shown in FIG. 4) and conductor 52 is coupled to a speaker (not shown in FIG. 4).

Either conductor may be pneumatic or electrical. In other words, there are four possible combinations: AC, AD, BC, BD, wherein A is a microphone in hearing aid 50 coupled pneumatically to the ear canal by conductor 51 in the form of a tube; B is a microphone in the ear canal coupled electrically to hearing aid 50 by conductor 51 in the form of an insulated wire; C is a speaker in hearing aid 50 coupled pneumatically to the ear canal by conductor 52 in the form of a tube, and D is a speaker in the ear canal coupled electrically to hearing aid 50 by conductor 52 in the form of an insulated wire. BD is preferred.

Hearing aid 50 operates in the same manner as hearing aid 10 to provide noise reduction for a hearing test. After the hearing test, filter 41 is programmed to result in the corrective gain for the subject.

FIG. 6 is a block diagram of signal processing circuitry that utilizes correlation rather than subtraction to find minimum noise. Specifically, the output from internal microphone 31 is correlated with the output signal from filter 41 in multiplier 63 to provide a control signal to filter 41. Minimum correlation indicates that the filter coefficients have been optimally set.

The invention thus provides a hearing aid that reduces noise in the ear canal and is suitable for use during a hearing test. The noise reduction circuitry can even be used during routine tasks, such as listening to a portable music player. The noise reduction takes place by filtering rather than by subtraction, which creates frequency dependent errors because of time delays. The noise reduction system is compatible with existing hearing tests, including self-tests, without the need for a special chamber and reduces the cost of a hearing test.

Having thus described the invention, it will be apparent to those of skill in the art that various modifications can be made within the scope of the invention. For example, the invention can be used in any hearing aid, not just the two types illustrated. The filter programming function is initiated, for example, by an external device inductively coupled to the hearing aid or by a steady tone of predetermined frequency and duration from an audiometer. One can determine minimum by monitoring the change in coefficients, as described above, or by monitoring the sound level in the chamber (the input from microphone 31, FIG. 1).

What is claimed as the invention is:

1. In a hearing aid having an external microphone, an internal microphone, and a speaker, the improvement comprising:
noise reduction circuitry including a programmable filter coupled to said external microphone, wherein the coefficients of the programmable filter are set in accordance with a signal from said internal microphone;
whereby the signal picked up by the internal microphone is minimized.

2. The hearing aid as set forth in claim 1 wherein said hearing aid is an in-the-ear-canal type of hearing aid.

3. The hearing aid as set forth in claim 1 wherein said hearing aid is an behind-the-ear type of hearing aid.

4. The hearing aid as set forth in claim 3 wherein said hearing aid is coupled to the ear canal by a first conductor coupled to said internal microphone and a second conductor coupled to said speaker.

5. The hearing aid as set forth in claim 1 wherein said filter is programmed for a transfer function that is substantially the inverse of the spectrum of the sound picked up by said internal microphone.

6. The hearing aid as set forth in claim 1 and further including a multiplier having a first input coupled to said internal microphone and a second input coupled to said speaker, wherein the coefficients of the programmable filter are set in accordance with a signal from said multiplier.
